(19) United States
(12) Patent Application Publication
(10) Pub. No.: US 2024/0118252 A1
(43) Pub. Date: Apr. 11, 2024

(54) ALLOCATING SAMPLE ANALYSIS TASKS TO ANALYTICAL DEVICES TO COMPLY WITH CONTROL TARGET

(71) Applicant: Agilent Technologies, Inc., Santa Clara, CA (US)

(72) Inventors: Kyle Robert Busch, Karlsruhe (DE); Stefan Mittrich, Kapsweyer (DE); Udo Herynek, Oetisheim (DE)

(73) Assignee: Agilent Technologies, Inc., Santa Clara, CA (US)

(21) Appl. No.: 18/377,978

(22) Filed: Oct. 9, 2023

(30) Foreign Application Priority Data
Oct. 11, 2022 (GB) 2214953.8

(51) Int. Cl. G01N 30/86; G01N 30/24

(52) U.S. Cl. CPC G01N 30/8658; G01N 30/24; G01N 2030/889

(57) ABSTRACT

In a method of allocating a plurality of functional tasks to a plurality of functional devices each capable of carrying out one or more of the functional tasks, the functional devices are analytical devices and each of the functional tasks corresponds to a respective predefined process related to analyzing a respective sample by a respective one of the functional devices. The functional tasks are allocated to the functional devices based on a criterion to achieve compliance with at least one predefined control target of controlling the functional devices.

### CROSS-REFERENCE TO RELATED APPLICATIONS

This application claims priority to UK Application No. GB 2214953.8, filed on Oct. 11, 2022, the entire contents of which are incorporated herein by reference.

### TECHNICAL FIELD

The present invention relates to a method of and a control unit for allocating a plurality of functional tasks to a plurality of functional devices, and to an arrangement.

### BACKGROUND

In liquid chromatography, a fluid (such as a mixture between a fluidic sample and a mobile phase) may be pumped through conduits and a column comprising a material (stationary phase) which is capable of separating different components of the fluidic sample. Such a material, so-called beads which may comprise silica gel, may be filled into a column which may be connected to other elements (like a sampling unit, a flow cell, containers including sample and/or buffers) by conduits.

Analytical devices, such as chromatographic sample separation apparatuses, are sometimes used in a pool of multiple analytical devices, for instance for industrial applications in pharmaceutical industry. However, efficiently operating analytical devices of such a device pool may be difficult.

### SUMMARY

It is an object of the invention to efficiently operate analytical devices, such as sample separation apparatuses, in particular of a device pool.

According to an exemplary embodiment of the present invention, a method of allocating a plurality of functional tasks to a plurality of functional devices each capable of carrying out one or more of said functional tasks is provided, wherein said functional devices are analytical devices and each of said functional tasks corresponds to a respective predefined process related to analyzing a respective sample by a respective one of said functional devices, and wherein the method comprises allocating the functional tasks to the functional devices based on a criterion to achieve compliance with at least one predefined control target of controlling the functional devices.

According to another exemplary embodiment of the invention, a control unit for allocating a plurality of functional tasks to a plurality of functional devices each capable of carrying out one or more of said functional tasks is provided, wherein said functional devices are analytical devices and each of said functional tasks corresponds to a respective predefined process related to analyzing a respective sample by a respective one of said functional devices, and wherein the control unit is configured for allocating the functional tasks to the functional devices based on a criterion to achieve compliance with at least one predefined control target of controlling the functional devices.

According to still another exemplary embodiment, an arrangement is provided which comprises a plurality of functional devices each capable of carrying out one or more functional tasks, wherein said functional devices are analytical devices and each of said functional tasks corresponds to a respective predefined process related to analyzing a respective sample by a respective one of said functional devices, and at least one control unit having the above mentioned features.

According to yet another exemplary embodiment of the invention, a program element (for instance a software routine, in source code or in executable code, for instance provided in form of an app) is provided, which, when being executed by a processor (such as a microprocessor or a CPU), is adapted to control or carry out a method having the above mentioned features.

According to yet another exemplary embodiment of the invention, a non-transitory computer-readable medium (for instance a CD, a DVD, a USB stick, a floppy disk or a hard disk, for instance located on a cloud) is provided, in which a computer program is stored which, when being executed by a processor (e.g., an electronic processor such as a microprocessor or a CPU), is adapted to control or carry out a method having the above mentioned features. The processor may be part of a control unit (or system controller, data processing unit, etc.) that is, or is part of, a computing device that includes one or more electronics-based processors, memories, user interfaces for input and/or output, and the like as appreciated by persons skilled in the art. For example, an embodiment of the present disclosure provides a non-transitory computer-readable medium that includes instructions stored thereon, such that when executed by a processor, the instructions perform and/or control the steps of the method of any of the embodiments disclosed herein.

Data processing which may be performed according to embodiments of the invention can be realized by a computer program, that is by software (e.g., computer-executable or machine-executable instructions or code), or by using one or more special electronic optimization circuits, that is in hardware, or in hybrid form, that is by means of software components and hardware components.

In the context of this application, the term “allocating functional tasks to functional devices” may particularly denote scheduling, for each of a plurality of functional tasks, which of a plurality of functional devices shall be operated for carrying out a respective functional task. In accordance with this allocation, the functional devices may then be operated for executing the assigned one or more functional tasks. Each individual functional device may thus be instructed to carry out a plurality of allocated functional tasks, only one allocated functional task, or no functional task. By a decided allocation key, the functional tasks may be distributed equally or unequally to the functional devices.

In the context of this application, the term “functional devices being analytical devices” may particularly denote that each functional device is configured for executing an analysis, in particular in terms of analyzing a sample. More particularly, a sample to be analyzed by a functional device may be a fluidic sample. Hence, the analytical device may be configured for handling a sample and for obtaining information related to said sample by executing an analysis. More specifically, a functional device being an analytical device may be a sample separation apparatus. Such a sample separation apparatus may particularly be an apparatus which is configured for separating a fluidic sample, for instance into different fractions. In particular, the sample separation apparatus may be a chromatography apparatus or an electrophoresis apparatus. When the fluidic sample is supplied to a chromatographic sample separation apparatus and is injected by an injector into a separation path between a fluid drive unit and a sample separation unit, different physical, chemical and/or biological properties of different fractions of the fluidic sample may result in a separation of different fractions in the sample separation unit.

In the context of this application, the term “each functional task corresponding to a respective predefined process related to analyzing a respective sample by a respective functional device” may particularly denote that a respective functional task may be defined by a set of data defining how a respective sample is to be analyzed by a functional device. Hence, said set of data may define or characterize said process. Correspondingly, different ones of the allocated tasks may relate to different processes which are to be executed for analyzing one or different samples. For instance, a functional task may be defined by a full set of data concerning a sample analysis method by which a specific sample is analyzed by a specific analysis method, the latter specifying a corresponding process by a dedicated set of operation parameters and/or instructions. A process may also comprise a plurality of sub-processes which are to be carried out in terms of the sample analysis. For the example of a chromatographic separation of a sample, such sub-processes may comprise loading a sample in an injector, establishing a flow of mobile phase between a fluid drive and a separation unit, injecting the sample from the injector into a flow path between the fluid drive and the separation unit, triggering separation of the sample in the separation unit by correspondingly adjusting a solvent composition of the mobile phase, and detecting the separated sample downstream of the separation unit. For instance, a respective process related to analyzing a respective sample by a respective functional device (also denoted as sample analysis process) may be a separation method, in particular a chromatographic separation method.

In the context of this application, the term “control target” may particularly denote the definition of one or more objects or goals which shall be achieved by the allocation of the functional tasks to the functional devices and by a corresponding control of the functional devices to execute the functional tasks in accordance with the allocation. For instance, such a control target may relate to expected wear and tear of the functional devices or functional parts thereof when executing functional tasks. A corresponding control target may then be to coordinate, in accordance with expected wear and tear, maintenance of functional devices or functional parts thereof and/or substitution of functional devices or functional parts thereof by other functional devices or functional parts thereof. In particular, the term “maintenance” may encompass functional checks, servicing and/or repairing a functional device or a functional part thereof. In particular, the term “substitution” may encompass replacing a functional device or a functional part thereof. Additionally or alternatively, another control target may relate to an overall quality of analysis results, for instance an optimization of overall quality or compliance with a predefined quality threshold, achievable by an allocation of the functional tasks to the functional devices. Additionally or alternatively, still another control target may relate to an overall energy consumption in terms of the analysis, for instance an optimization of overall energy consumption or compliance with a predefined energy consumption threshold, achievable by an allocation of the functional tasks to the functional devices. The allocation may be carried out based on one of the mentioned and/or other control targets, or based on any combination of plural of the mentioned and/or other control targets.

In the context of this application, the term “control unit” may particularly denote a controlling entity (such as one or more processors or part of a processor) controlling allocation of functional tasks to functional devices. In this context, the control unit may carry out calculations, may execute algorithms, may involve artificial intelligence, may carry out simulations, may make use of historic allocation information and/or other empirical data, for determining an allocation complying with one more control targets. The control unit may also communicate with the functional devices or functional parts thereof to instruct them to execute allocated functional tasks. For instance, the control unit may communicate with controllers of the functional devices, which controllers may control a process of analyzing a sample on the assigned functional device. In another embodiment, the control unit may also directly control a process of analyzing a sample on a respective functional device to which the corresponding task is allocated.

In the context of this application, the term “sample” may particularly denote any (in particular fluidic, i.e. liquid and/or gaseous) medium, which is to be analyzed, in particular separated. Such a sample may comprise a plurality of different molecules or particles which shall be analyzed (in particular separated), for instance small mass molecules or large mass biomolecules such as proteins. Separation of a sample may involve a certain separation criterion (such as mass, volume, chemical properties, etc.) according to which a separation is carried out.

According to an exemplary embodiment of the invention, plural functional tasks are allocated to plural functional devices for making a schedule which functional device(s) will execute which functional task(s). The functional devices are analytical devices configured for executing functional tasks defining processes related to sample analysis. Advantageously, allocation of the functional tasks to the functional devices may be carried out based on the criterion to achieve compliance with one or more predefined control targets which are related with the control of the functional devices. By defining one or more control targets, which shall be achieved by the utilization of a pool of analytical devices for analyzing samples, as a basis for the decision as to how different sample analysis processes shall be allocated to the analytical devices, a smart allocation, rather than an arbitrary use, of analytical devices of a pool may be controlled. Such a control target based intelligent allocation architecture may render it possible to efficiently operate the available analytical devices, such as sample separation apparatuses, in particular of a device pool.

As an example related to an embodiment, the allocation of the sample analysis processes to the analytical devices may be controlled for temporally coordinating maintenance times at which the analytical devices or functional parts thereof need maintenance. For instance, it may be desired that all analytical devices are due for maintenance at the same point of time, so that the maintenance effort can be significantly reduced. In order to achieve a corresponding control target, sample analysis processes may be allocated to the analytical devices so that wear and tear of all analytical devices is the same at a common maintenance time. Thus, a control target may correspond to wear and tear-related events or properties. A skilled person will however understand that the aforementioned is only one example for a control target, and that other control targets (in particular related to energy consumption and/or analysis quality) may be considered additionally or alternatively, as described below.

In the following, further embodiments of the control unit, the method, and the arrangement will be explained.

As mentioned above, a respective sample analysis process may be a separation method, in particular a chromatographic separation method. In the context of the present application, the term “separation method” may in particular denote an instruction for a sample separation apparatus-type analytical device as to how to separate a fluidic sample, which is to be carried out by the sample separation apparatus in order to fulfill a separation task associated with the separation method. Such a separation method can be defined by a set of parameter values (for example temperature, pressure, characteristic of a solvent composition, etc.) and hardware components of the sample separation apparatus (for example the type of separation column used) and an algorithm with commands or instructions that are executed when the separation method is carried out. A corresponding set of technical parameters for operating the sample separation apparatus during sample separation may be pre-known, for instance stored in a database or memory accessible by a controller controlling operation of the sample separation apparatus. Physical properties or operation parameters characterizing a separation method may involve a transport characteristic which may include parameters such as volumes, dimensions, values of physical parameters such as pressure or temperature, and/or physical effects such as a model of friction occurring in a fluidic conduit which friction effects may be modeled, for example, according to the Hagen Poiseuille law. More particularly, the parameterization may consider dimensions of a sample separation apparatus (for instance a dimension of a fluidic channel), a volume of a fluid conduit (such as a dead volume) of the sample separation apparatus, a pump performance (such as the pump power and/or pump capacity) of the sample separation apparatus, a delay parameter (such as a delay time after switching on a sample separation apparatus) of operating the sample separation apparatus, a friction parameter (for instance characterizing friction between a wall of a fluidic conduit and a fluid flowing through the conduit) of operating the sample separation apparatus, a flush performance (particularly properties related to rinsing or flushing the sample separation apparatus before operating it or between two subsequent operations) of the sample separation apparatus, and/or a cooperation of different components of the sample separation apparatus (for instance the properties of a gradient applied to a chromatographic column).

In an embodiment, at least one of the at least one predefined control target is related to wear and tear of the functional devices or of individual functional parts (i.e. members of an analytical device, such as a pump, a degasser, an injector, a separation column, a detector, or a seal of an analytical device) of at least some of the functional devices when carrying out the allocated functional tasks. During executing a sample analysis process, an analytical device may be subjected to wear and tear. This also applies to each individual functional part of such an analytical device. The amount of wear and tear of the analytical device or a respective functional part thereof may depend on the characteristics of the analytical device or functional part (for instance a type of implemented seal). However, the amount of wear and tear of the analytical device or a respective functional part thereof may also depend on the characteristics of the sample analysis process (for example, wear and tear exerted to a seal may be larger at higher fluid pressure and higher flow rate compared with lower fluid pressure and lower flow rate). Hence, when wear and tear of the analytical devices or functional parts thereof due to the execution of a sample analysis process is considered for the allocation of sample analysis processes to the different analytical devices, events such as maintenance and/or substitution of analytical devices or functional parts thereof may be planned more efficiently.

In an embodiment, the method comprises allocating the functional tasks to the functional devices so that at one or more temporally coordinated maintenance times of the functional devices or of individual functional parts of at least some of the functional devices wear and tear of the functional devices or of individual functional parts of at least some of the functional devices is balanced. In a conventional approach, maintenance is due for an analytical device when its wear and tear has reached a certain level. However, this may lead conventionally to the result that different analytical devices are due for maintenance at arbitrary and very different points of time, which may involve a high overall maintenance effort, because maintenance staff must be hired for each individual maintenance event. In contrast to such a conventional approach, the described exemplary embodiment allocates sample analysis processes to the analytical devices so that at one or more temporally coordinated maintenance times, different analytical devices or functional parts thereof have balanced wear and tear. For example, the allocation of the sample analysis processes to the analytical devices may be carried out so that expected wear and tear of the analytical devices or functional parts thereof is well-balanced or equalized at a future predefined maintenance time. In contrast to an arbitrary and uncontrolled time for maintenance in conventional approaches, the described exemplary embodiment actively distributes sample analysis processes to the functional devices for balancing wear and tear between the different analytical devices. This may be done to achieve compliance with a predefined temporal maintenance plan, so that each analytical device may proceed to maintenance when having reached a certain planned wear and tear level. Coordinating the wear and tear levels of the different analytical devices may be achieved by correspondingly allocating the sample analysis processes to the analytical devices.

In an embodiment, at least one of the at least one predefined control target is related to a temporal coordination when maintenance for the individual functional devices or for individual functional parts of at least some of the functional devices falls due. Hence, a temporal coordination of maintenance times (for instance a time schedule indicating when the individual analytical devices shall be due for maintenance) for the analytical devices may be defined as a control target. Allocation of the sample analysis processes to the analytical devices may then be controlled so that wear and tear of the analytical devices or functional parts thereof reaches a level after execution of the allocated sample analysis processes which leads to a need for maintenance of the analytical devices in accordance with the temporal coordination of maintenance time(s).

In an embodiment, at least one of the at least one predefined control target is related to a temporal coordination when the individual functional devices or individual functional parts of at least some of the functional devices reach an end of lifetime and require substitution. Due to wear and tear during execution of sample analysis processes, analytical devices or functional parts thereof may reach the end of its lifetime and may require substitution or exchange. For example, a seal shall be completely exchanged after a certain number of pressure cycles or a chromatographic separation column shall be exchanged after a certain number of separation runs. In a conventional approach, substitution of functional parts or an entire analytical device is passively done when the end of lifetime is reached. However, this approach may involve high effort, since this makes necessary substitution at non-coordinated times. In contrast to this, the described exemplary embodiment of the invention schedules and allocates sample analysis processes to the analytical devices so that an end of lifetime of each respective analytical device or functional part thereof is achieved at a controlled and predictable future time due to a predictable addition of wear and tear as a consequence of the allocated sample analysis processes. As a result, substitution of entire analytical devices or functional parts of different analytical devices may be temporarily coordinated in a predictive and controlled way. For instance, the allocation may be done so that a group of analytical devices (or functional parts thereof) or even all analytical devices (or functional parts thereof) reach an end of lifetime simultaneously. This may reduce the effort involved with the substitution, since a single substitution process or a few substitution processes (for groups of analytical devices) may be sufficient for an entire pool of functional devices.

In an embodiment, at least one of the at least one predefined control target is that maintenance for the individual functional devices or individual functional parts of at least some of the functional devices falls due temporally synchronized. For example, the allocation of the sample analysis processes to the functional devices may be carried out so that a predefined time schedule for maintenance of the analytical devices is achieved by ensuring that wear and tear of the analytical devices resulting from the allocated sample analysis processes leads to a device-specific maintenance time in accordance with a temporary synchronized maintenance plan for the different analytical devices. Hence, maintenance for an individual analytical device will not fall due arbitrarily, but temporally synchronized with other analytical devices of the pool.

In an embodiment, at least one of the at least one predefined control target is that maintenance for the individual functional devices or individual functional parts of at least some of the functional devices falls due within a predefined common time interval, in particular at the same time. For example, allocation of the sample analysis processes to the analytical devices may be controlled so that all analytical devices are due for maintenance at the same point of time or within a defined maintenance time interval. Advantageously, this allows to temporally concentrate maintenance to a certain point of time or to a certain limited time interval, so that maintenance effort will occur only at a predefined point of time or within a predefined maintenance interval. For instance, maintenance staff may carry out maintenance for all analytical devices at the same time or within the same predefined maintenance interval, which eliminates the need to individually order maintenance personnel for each and every analytical device of a pool separately at an arbitrary non-predictable point of time. Further advantageously, this may also reduce the downtime of analytical devices in view of maintenance.

In another embodiment, at least one of the at least one predefined control target is that maintenance for different groups of the individual functional devices or different groups of individual functional parts of at least some of the functional devices falls due within different predefined time intervals for different groups, in particular at different times for different groups. In certain scenarios, it may be undesired that all analytical devices of a pool are out of service at the same maintenance time or during the same maintenance time interval. An example is a pharmaceutical plant in which manufactured pharmaceuticals need permanent analysis for continuously guaranteeing compliance of a manufacturing process with certain quality requirements. If all analytical devices (for instance HPLCs) in such a plant were out of service due to maintenance at the same time, the entire pharmaceutical plant might require a downtime. In order to avoid such scenarios, the presently described embodiment groups the analytical devices into at least two different groups (for example two groups each having half of the analytical devices) and allocates the sample analysis processes to the analytical devices of the groups so that a resulting wear and tear leads to different maintenance times or non-overlapping maintenance time intervals for the different groups. This may ensure that, at each time, at least one group of analytical devices is presently not under maintenance and therefore free to carry out sample analysis processes. At the same time, grouping maintenance in a controlled way rather than executing maintenance in an arbitrary way for each individual analytical device may reduce the overall maintenance effort.

In an embodiment, the method comprises estimating an expected maintenance time and/or an expected end of lifetime for at least some of said functional devices or for individual functional parts of at least some of the functional devices as a basis for assessing the at least one predefined (in particular wear and tear-related) control target. Hence, a prediction may be made for the individual functional devices when in the future they will be due for maintenance or will require complete substitution. Such a prediction may be made for example on the basis of a calculation, a simulation, a numerical analysis, modelling, application of expert rules and/or use of empirical data.

In an embodiment, the method comprises estimating an expected maintenance time and/or an expected end of lifetime for at least some of said functional devices or for individual functional parts of at least some of the functional devices based on an intended use of a respective one of said functional devices or of individual functional parts of at least some of the functional devices in the future. In order to make such a meaningful prediction of expected maintenance time or end of lifetime, sample analysis processes planned to be executed by a respective analytical device in the future may be considered, since each sample analysis process may add wear and tear to the corresponding analytical device. For example, sample analysis processes which shall be allocated to a respective analytical device with its functional parts may be assessed in terms of corresponding wear and tear. For instance, this may involve accessing a database indicating for the individual functional parts of an analytical device which amount of wear and tear is exerted to each functional part for each sample analysis process or sub-process thereof. As an example, wear and tear of a seal of an analytical device may be indicated in such a database depending on pressure, flow rate and/or any other operation parameters of a corresponding sample analysis process (for example chromatographic separation method). In said database, the amount of wear and tear may be indicated as a time slot. When the number of time slots of a functional component or the entire analytical device sum up, for the allocated sample analysis processes, to a predefined maintenance time value or lifetime value, a need for maintenance or substitution may be assumed. The described approach allows to estimate or precisely predict an expected maintenance time or end of lifetime in view of expected future use.

In an embodiment, the method comprises estimating an expected maintenance time and/or an expected end of lifetime for at least some of said functional devices or for individual functional parts of at least some of the functional devices based on an actual use of a respective one of said functional devices or of individual functional parts of at least some of the functional devices in the past. In a similar way as described in the preceding paragraph for allocated future use of analytical devices, also past use of analytical devices for executing sample analysis processes may be considered when predicting a future maintenance time or expected end of lifetime. However, considering use of analytical devices in the past and thereby considering corresponding contributions to wear and tear may be even more straightforward since actually executed past sample analysis processes may allow a simple and precise calculation of corresponding wear and tear, while predicting future wear and tear may require certain assumptions concerning planned future use.

In an embodiment, the method comprises estimating an expected maintenance time and/or an expected end of lifetime for at least some of said functional devices or for individual functional parts of at least some of the functional devices based on preknown attributes of a respective one of said functional devices or of individual functional parts of at least some of the functional devices and/or based on preknown attributes of said functional tasks. In particular, attributes of a respective analytical device or functional parts thereof may define corresponding hardware characteristics. For instance, a type of seal used in a high-pressure pump of the analytical device may be such an attribute. Descriptively speaking, considering the attributes of the analytical device as a basis for an estimation of maintenance time and/or end of lifetime may involve a parameterization of the analytical device on hardware level. Correspondingly, attributes of a respective sample analysis process may define the latter in terms of process parameters. For example, a mobile phase pressure and/or a mobile phase flow rate applied to the analytical device during execution of the sample analysis process may be such attributes. In particular, said attributes of a sample analysis process may correspond to a parameter set of a chromatographic separation method, as explained above. Since wear and tear of hardware components of the analytical device may depend on attributes of a sample analysis process executed on such an analytical device, considering both hardware and process attributes may lead to a meaningful prediction of estimated maintenance time and/or estimated end of lifetime.

In particular a combination of an actual past and a planned future use of individual analytical devices, together with attributes characterizing analytical devices and sample analysis processes executed thereon (as described individually in the preceding paragraphs) may allow a reliable prediction of maintenance time and/or end of lifetime. Hence, said combination may form a highly appropriate basis for a meaningful allocation of sample analysis processes to different analytical devices of a pool.

In an embodiment, the method comprises allocating less functional tasks to a respective one of said functional devices or to an individual functional part of a respective one of said functional devices being closer to an expected maintenance time or being closer to an expected end of lifetime compared with at least one other functional device or compared with a corresponding other functional part of at least one other functional device. Hence, one measure which may be taken for properly balancing sample analysis processes to the various analytical devices may be to allocate more sample analysis processes to an analytical device which has not yet experienced an excessive amount of wear and tear compared with another analytical device to which already a high amount of wear and tear has been exerted in view of many and/or demanding sample analysis processes carried out thereon. Such an unequal allocation of future sample analysis processes to the analytical devices may lead to a homogeneous or at least a more homogeneous wear and tear of the analytical devices after execution of the allocated future sample analysis processes. For example, the allocation may then lead to a partial or full synchronization of the analytical devices what concerns the predicted maintenance time and/or predicted end of lifetime.

In an embodiment, at least one of the at least one predefined control target is related to a quality of results of analyzing samples, in particular to an accuracy of a separation of analyzed samples in separated sample components, when the functional devices or individual functional parts of at least some of the functional devices carry out the allocated functional tasks. For example, a part of sample analysis processes to be carried out in the future may be more demanding than another part of future sample analysis processes what concerns accuracy of the analysis results. For example, such more demanding sample analysis processes may require an analytical device having a higher functional level than other analytical devices of the pool. For ensuring a high quality of the sample analysis result (for instance a high resolution of peaks in a chromatogram), such more demanding sample analysis processes may be allocated to analytical devices with higher level of functionality, whereas less demanding sample analysis processes (in particular less demanding in terms of required accuracy of analysis results) may be allocated to analytical devices with lower level of functionality. For instance, a level of functionality may be correlated with an accuracy of solvent composition of a respective functional device, maximum supported mobile phase pressure, and/or guaranteed peak width in a chromatogram. By taking this measure, the analytical device resources may be assigned properly to the sample analysis processes to be executed, so that the overall quality level of results of the sample analysis processes can be high, or even maximized. For achieving compliance with a control target related to the quality of results of analyzing samples, the sample analysis processes may be allocated to the analytical devices so that, for each of the sample analysis processes, a corresponding predefined quality criterion (for instance a predefined resolution level of sample separation) is fulfilled by the allocation. To put it shortly, the allocation may be made in accordance with the control target to ensure that the quality of measurement results complies with a given specification. For example, the quality-related control target may be to achieve at least a predefined resolution of sample analysis, in particular sample separation.

In an embodiment, at least one of the at least one predefined control target is related to an energy consumption of the functional devices or individual functional parts of at least some of the functional devices when carrying out the allocated functional tasks. During operation of an analytical device, energy will be consumed. For instance, energy is required for operating a high-pressure pump for conveying mobile phase and sample, for heating a column oven for separating the sample, for optical detection of analyzed sample, etc. The energy consumption may depend both on the hardware of the used analytical device (since different functional parts thereof may have different energy consumption) and/or on the characteristics of the sample analysis process (which may be defined by energy consumption-related operation parameters, such as pressure, flow rate and temperature). When allocating the sample analysis processes to the analytical devices, the control target may be considered that an energy consumption-related criterion is fulfilled. For example, such an energy consumption-related criterion may be that a predefined energy consumption threshold is not exceeded, wherein such an energy consumption threshold may for instance be related to an individual sample analysis process or to all sample analysis processes in combination. Another control target may be to minimize an overall energy consumption for all sample analysis processes to be allocated.

In an embodiment, at least one of the at least one predefined control target is that wear and tear of at least one selected functional device shall be smaller than wear and tear of at least one other of the functional devices. In particular, it is also possible to select a specific analytical device for a certain sample analysis process based on the criterion that the sample analysis process is allocated to the analytical device which experiences the smallest amount of wear and tear of all analytical devices.

In an embodiment, at least one of the at least one predefined control target is that a number of sets of functional tasks executed by the functional devices meets a predefined target specification, in particular is maximized. Hence, a criterion for allocation of sample analysis processes to analytical devices may also be that a number of executed sample analysis processes per time is as large as possible, or is at least larger than a predefined threshold value.

In an embodiment, the method comprises dynamically adjusting at least one maintenance time at which maintenance of the functional devices or at least an individual functional part of the functional devices is due. Dynamically adjusting a maintenance time may denote a change of a defined maintenance time over time (and correspondingly a change in allocation of sample analysis processes to functional devices over time). For instance, the allocation of the sample analysis processes to the analytical devices may be changed flexibly when a control target changes, when the sample analysis processes to be allocated change, and/or when the number of functional devices of a pool change over time. For instance, it may be possible that an already completed allocation may be changed when additional sample analysis processes are added to a task list or sample analysis processes are removed from a task list. Is also possible that analytical devices are removed from a pool or are added to the pool. Such events may lead to a re-scheduling and a corresponding dynamic re-allocation of sample analysis processes to analytical devices.

In an embodiment, the functional tasks are grouped into sets of functional tasks, and wherein the method comprises allocating each set of the functional tasks to only one of said functional devices. For instance, one set of functional tasks may relate to liquid chromatography applications, whereas another set of functional tasks may relate to electrophoresis. The different capability of the different analytical devices may then be considered for the allocation of tasks. It is also possible that all sample analysis processes of a set shall be executed by one functional device, for example in order to obtain directly comparable results.

In an embodiment, the functional devices are sample separation apparatuses for separating a fluidic sample. Such analytical devices may thus be configured for separating a fluidic sample, in particular in different fractions. In particular, the functional devices may be chromatography separation apparatuses.

In an embodiment, each sample separation apparatus comprises a fluid drive unit configured for driving a mobile phase and the fluidic sample injected in the mobile phase, and a sample separation unit configured for separating the fluidic sample in the mobile phase. In the context of this application, the term “mobile phase” may particularly denote any liquid and/or gaseous medium which may serve as fluidic carrier of the fluidic sample during separation. A mobile phase may be a solvent or a solvent composition (for instance composed of water and an organic solvent such as ethanol or acetonitrile). In an isocratic separation mode of a liquid chromatography apparatus, the mobile phase may have a constant composition over time. In a gradient mode, however, the composition of the mobile phase may be changed over time, in particular to desorb fractions of the fluidic sample which have previously been adsorbed to a stationary phase of a sample separation unit. In the context of the present application, the term “fluid drive unit” may particularly denote an entity capable of driving a fluid, in particular the fluidic sample and/or the mobile phase. For instance, the fluid drive may be a pump (for instance embodied as piston pump or peristaltic pump) or another source of pressure. For instance, the fluid drive unit may be a high-pressure pump, for example capable of driving a fluid with a pressure of at least 100 bar, in particular at least 1000 bar. The term “sample separation unit” may particularly denote a fluidic member through which a fluidic sample is transferred, and which is configured so that, upon conducting the fluidic sample through the separation unit, the fluidic sample will be separated into different groups of molecules or particles. An example for a separation unit is a liquid chromatography column which is capable of trapping or retarding and selectively releasing different fractions of the fluidic sample. In particular, a sample separation unit may be a tubular body. For instance, a length of a sample separation unit may be in a range from 80 mm to 300 mm, for example 100 mm. In particular, each sample separation apparatus may be a chromatographic sample separation apparatus, such as an HPLC.

In an embodiment, the plurality of functional devices form part of a localized system, such as a fleet, a lab, or a site. However, said localized system may also relate to a common device type or functional devices comprising a common component. For instance, the localized system may comprise a pool of functional devices being related to a manufacturing plant, in particular a pharmaceutical manufacturing plant.

The sample separation unit may be filled with a separating material. Such a separating material which may also be denoted as a stationary phase may be any material which allows an adjustable degree of interaction with a sample fluid so as to be capable of separating different components of such a sample fluid. The separating material may be a liquid chromatography column filling material or packing material comprising at least one of the group consisting of polystyrene, zeolite, polyvinylalcohol, polytetrafluorethylene, glass, polymeric powder, silicon dioxide, and silica gel, or any of above with chemically modified (coated, capped etc.) surface. However, any packing material can be used which has material properties allowing an analyte passing through this material to be separated into different components, for instance due to different kinds of interactions or affinities between the packing material and fractions of the analyte.

At least a part of the sample separation unit may be filled with a fluid separating material, wherein the fluid separating material may comprise beads having a size in the range of essentially 1 μm to essentially 50 μm. Thus, these beads may be small particles which may be filled inside the separation section of the microfluidic device. The beads may have pores having a size in the range of essentially 0.01 μm to essentially 0.2 μm. The fluidic sample may be passed through the pores, wherein an interaction may occur between the fluidic sample and the pores.

The sample separation unit may be a chromatographic column for separating components of the fluidic sample. Therefore, exemplary embodiments may be particularly implemented in the context of a liquid chromatography apparatus.

The sample separation apparatus may be configured to conduct a liquid mobile phase through the sample separation unit. As an alternative to a liquid mobile phase, a gaseous mobile phase or a mobile phase including solid particles may be processed using the sample separation apparatus. Also materials being mixtures of different phases (solid, liquid, gaseous) may be processed using exemplary embodiments. The sample separation apparatus may be configured to conduct the mobile phase through the system with a high pressure, particularly of at least 600 bar, more particularly of at least 1200 bar.

The sample separation apparatus may be configured as a microfluidic device. The term “microfluidic device” may particularly denote a sample separation apparatus as described herein which allows to convey fluid through microchannels having a dimension in the order of magnitude of less than 500 μm, particularly less than 200 μm, more particularly less than 100 μm or less than 50 μm or less.

Exemplary embodiments of the sample separation apparatus may be implemented with a sample injector which may take up a sample fluid from a fluid container and may inject such a sample fluid in a conduit for supply to a separation column. During this procedure, the sample fluid may be compressed from, for instance, normal pressure to a higher pressure of, for instance several hundred bars or even 1000 bar and more. An autosampler may automatically inject a sample fluid from the vial into a sample loop. A tip or needle of the autosampler may dip into a fluid container, may suck fluid into the capillary and may then drive back into a seat to then, for instance via a switchable fluidic valve, inject the sample fluid towards a sample separation section of the liquid chromatography apparatus.

The sample separation apparatus may be configured to analyze at least one physical, chemical and/or biological parameter of at least one component of the sample fluid in the mobile phase. The term “physical parameter” may particularly denote a size or a temperature of the fluid. The term “chemical parameter” may particularly denote a concentration of a fraction of the analyte, an affinity parameter, or the like. The term “biological parameter” may particularly denote a concentration of a protein, a gene or the like in a biochemical solution, a biological activity of a component, etc.

The sample separation apparatus may be implemented in different technical environments, like a sensor device, a test device, a device for chemical, biological and/or pharmaceutical analysis, a capillary electrophoresis (CE) device, a liquid chromatography (LC) device, a gas chromatography (GC) device, an electronic measurement device, or a mass spectrometry (MS) device. Particularly, the sample separation apparatus may be a High Performance Liquid device (HPLC) device by which different fractions of an analyte may be separated, examined, and analyzed.

An embodiment of the present invention comprises a sample separation apparatus configured for separating compounds of a sample fluid in a mobile phase. The sample separation apparatus comprises a mobile phase drive, such as a pumping system, configured to drive the mobile phase through the sample separation apparatus. A sample separation unit, which can be a chromatographic column, is provided for separating compounds of the sample fluid in the mobile phase. The sample separation apparatus may further comprise a sample injector configured to introduce the sample fluid into the mobile phase, a detector configured to detect separated compounds of the sample fluid, a collector configured to collect separated compounds of the sample fluid, a data processing unit configured to process data received from the fluid separation system, and/or a degassing apparatus for degassing the mobile phase.

Embodiments may be implemented in conventionally available HPLC systems, such as the analytical Agilent 1290 Infinity II LC system or the Agilent 1290 Infinity II Preparative LC/MSD system (both provided by the applicant Agilent Technologies—see www.agilent.com).

One embodiment comprises a pumping apparatus having a piston for reciprocation in a pump working chamber to compress liquid in the pump working chamber to a high pressure at which compressibility of the liquid becomes noticeable. One embodiment comprises two pumping apparatuses coupled either in a serial or parallel manner.

The mobile phase (or eluent) can be either a pure solvent or a mixture of different solvents. It can be chosen for instance to minimize the retention of the compounds of interest and/or the amount of mobile phase to run the chromatography. The mobile phase can also been chosen so that the different compounds can be separated effectively. The mobile phase may comprise an organic solvent like for instance methanol or acetonitrile, often diluted with water. For gradient operation water and organic is delivered in separate bottles, from which the gradient pump delivers a programmed blend to the system. Other commonly used solvents may be isopropanol, THF, hexane, ethanol and/or any combination thereof or any combination of these with aforementioned solvents.

The sample fluid or fluidic sample may comprise any type of process liquid, natural sample like juice, body fluids like plasma or it may be the result of a reaction like from a fermentation broth.

The fluid is typically a liquid but may also be or comprise a gas and/or a supercritical fluid (as for instance used in supercritical fluid chromatography—SFC).

### BRIEF DESCRIPTION OF DRAWINGS

Other objects and many of the attendant advantages of embodiments of the present invention will be readily appreciated and become better understood by reference to the following more detailed description of embodiments in connection with the accompanying drawings. Features that are substantially or functionally equal or similar will be referred to by the same reference signs.

FIG. 1 shows a sample separation apparatus in accordance with embodiments of the present invention, particularly used in high performance liquid chromatography (HPLC), in combination with further sample separation apparatuses and a central control unit.

FIG. 2 illustrates an arrangement with functional devices and a control unit according to an exemplary embodiment.

FIG. 3 is a diagram illustrating a working principle of a method, a control unit, and an arrangement according to an exemplary embodiment.

The illustrations in the drawings are schematic.

### DETAILED DESCRIPTION

Before, referring to the figures, exemplary embodiments will be explained in further detail, some basic considerations will be explained based on which exemplary embodiments have been developed.

According to an exemplary embodiment of the present invention, functional tasks in the form of sample analysis processes are allocated in a smart manner to a set of available functional devices embodied as analytical devices. Advantageously, said allocation may be made by requiring compliance with one or more predefined control targets of controlling the analytical devices. This may lead to a controlled and efficient use of analytical devices of a device pool, rather than an arbitrary and sometimes inefficient use as in conventional approaches.

For example, maintenance times for the analytical devices may no more be random or arbitrary, but can be scheduled in a controlled way by selectively adjusting wear and tear of the individual analytical devices thanks to an intelligent criterion-based allocation of sample analysis processes to the analytical devices.

In an embodiment, analytical devices may be used in accordance with at least one control target for rendering maintenance timing for the analytical devices efficiently. For instance, the allocation may be done so that maintenance times for several or even all analytical devices of a pool fall together. Thus, the use of (for example at least five or at least ten) analytical devices in a lab may no longer be arbitrary, but in accordance with a well-defined control target (for example ensuring that maintenance times are concentrated). For example, said control target may be that all analytical devices are used so that they experience an equal wear and tear, and are therefore due for maintenance all at the same time.

An exemplary use of for example five HPLCs of a device pool in a lab would be as follows: A first HPLC which has not been used excessively in the past has consequently only experienced small wear and tear. In contrast to this, a second HPLC which has been used more intensively in the past has already experienced more wear and tear. In order to obtain a common maintenance time for the HPLCs, more sample analysis processes will be allocated to the second HPLC compared with the first HPLC. The allocation may be adjusted so that wear and tear of the first and second HPLCs are the same at a common maintenance point of time at which both are due for maintenance and will in fact obtain maintenance. Hence, frequency of use may be balanced between the different HPLCs taking into account both past use and allocated future use. The allocation of future HPLC tasks to the HPLCs may be made under consideration of expected wear and tear for each specific HPLC task, which may depend on particularities of the individual HPLC tasks (for instance pressure and flow rate) and on hardware properties of the HPLCs (for instance a type of used seal). Thus, expected wear and tear may be properly calculated or modeled as a basis for the allocation. To put it shortly, expected wear and tear of each functional part of each HPLC may be determined or estimated for each HPLC task to be allocated, and the allocation may be made accordingly.

In particular, an embodiment of the invention may determine dynamic maintenance intervals based on instrument usage. A corresponding gist may be to balance the utilization of plural analytical devices, so that maintenance for these analytical devices ideally falls together on one point in time. In other words, the utilization of these analytical devices may be controlled so that wear and tear of these analytical devices is substantially equal and accordingly maintenance intervals substantially fall together. Advantageously, knowledge and understanding of previous as well as future or planned utilization may be taken into account, and additionally also properties of the analytical devices itself. An advantage of a corresponding embodiment is that maintenance cycles for such plural analytical devices ideally fall together, thus leading to a reduction in maintenance effort. Analytical devices (such as chromatography sample separation apparatuses) may be operated in accordance with a plan what analysis (in particular what kind and type of analysis) is to be done (and optionally also by when). Further, each analysis (or sample analysis process) may be clearly defined for example by a given chromatographic method to be run on the analytical device. Advantageously, this may allow a deterministic planning of the utilization of plural analytical devices, and not randomly.

According to an exemplary embodiment, dynamic maintenance intervals can be defined based upon instrument usage, i.e. in accordance with allocated sample analysis processes carried out by an analytical device or instrument. Hence, it may be possible to predict and define an expected date when maintenance is needed for an individual functional device configured as analytical device based on the usage rate of the analytical device (such as an HPLC) and its respective functional parts (for instance a gasket, a chromatographic column, etc.). The analytical device (for instance an HPLC instrument) itself or a central control unit can determine at which date each functional part and the analytical device as a whole may require maintenance by considering a usage history to project what date the maintenance limit will be reached. This can be constantly updated because users may have times where an analytical device is used more than the typical or average amount.

In embodiments, a user of an analytical device or a pool of analytical devices may also have the opportunity to set a maximum expected usage date, as many analytical devices may require regular (for example yearly) maintenance intervals. In an embodiment, the dynamic maintenance interval can also notify the user before running a sequence or single run how much this analysis will change the projected maintenance needed date before the user runs the analysis. To allow planning maintenance with the dynamic maintenance interval, a warning threshold can be defined to get notified when approaching the critical date.

A control unit may also care about a management of maintenance for a fleet of analytical devices and may constantly monitor the dynamic maintenance dates. The control unit or any other management system can propose an optimum maintenance window to a user to reduce or even optimize downtimes and service efforts for technicians, such as maintenance staff. The user can remain constantly informed about when maintenance is needed to avoid downtime. The user can see how the usage of one or more analytical devices is affecting the maintenance interval and/or health of the system. The user can determine if an analytical sequence should be run because the dynamic maintenance interval can provide a wear factor for the analysis. The user can then determine if a, for example less important, analysis should be run based on how the maintenance interval of the system will be affected at the expense of requiring a maintenance at an earlier date.

According to exemplary embodiments of the invention, a control unit or an analytical device itself may predict at what time a functional part of component should be serviced or replaced based on information regarding the stress exerted on that functional part during a sample analysis process.

Advantageously, exemplary embodiments of the invention may make it possible to improve or even optimize predictive maintenance across a set of analytical devices in a laboratory, at a location, of a device type, with a certain component, etc.

The use of a device type in a laboratory may be planned in such a way that, for example, functional part X can be replaced or maintained at one appointment for all or at least a part of the analytical devices, in such a way that each functional part X of said some or all analytical devices has actually completed its life cycle.

Moreover, analysis planning may be accomplished based on the predicted or determinable maintenance times. A sequence or an analysis plan can be managed advantageously with regard to various requirements. For example, a requirement can be that functional part X should experience wear and tear as little as possible. Beyond this, one requirement can be the number of sample analysis processes to be performed. If, for example, this is to be maximized, the sample analysis processes may be carried out in the order of their potential wear contribution. For both aspects, it may be advantageous that wear contributions of the respective sample analysis process or individual sub process thereof (such as rinsing, leakage tests, etc.) are considered as a basis for the control. For instance, corresponding wear and tear information can be collected by recording changes in state variables (for example valve switching times) over a large number of analytical runs for a certain sample analysis process and interpolating this data. This type of predictive maintenance may be executed without looking at a previously set threshold value or similar.

An exemplary embodiment of the invention relates to predictive maintenance, i.e. the predictive monitoring of analytical devices. According to an embodiment, functional tasks in the form of sample analysis processes may be distributed or allocated to different functional devices in the form of analytical devices in order to achieve a common or similar maintenance date for these analytical devices, or at least part thereof. In other words, the utilization of multiple analytical devices may be controlled in such a way that it results in a common (planned or resulting) maintenance date or maintenance time for all (or at least some or most) of these analytical devices. An analytical device that is about to be serviced may be deferred compared to other analytical devices that still have a longer time until the next maintenance. In other words, sample analysis processes may be allocated to run on analytical devices with an even longer time up to next maintenance. With a dynamic determination of the maintenance date based on the current utilization, see subsequent paragraph, the maintenance dates of several analytical devices can be merged.

According to an embodiment of the invention (which may also be combined with the aforementioned embodiment), data concerning the use of an analytical device in the past as well as the current and planned future may be used to determine a future maintenance date. In particular the inclusion of the planned future use is highly advantageous in this respect.

In particular, exemplary embodiments of the invention can be carried out in the framework of the following scenario: A laboratory may operate with a plurality of analytical devices, such as liquid chromatography apparatuses for sample separation. The laboratory may accept orders in the form of samples to be analyzed, i.e. different sample analysis processes to be executed. In general, the sequence, size and type of sample analysis processes may be unpredictable. The analysis of the samples may be linked to a delivery date (for example within a few days). A sample analysis process may be a liquid chromatography method designed to analyze the samples of an order, wherein the number of samples can range for example from 1 to 100 or even higher (i.e. a sequence of sample analysis processes may be executed). Several different analytical devices (such as liquid chromatography apparatuses) may be available for carrying out a respective sample analysis process, so that there may be a certain freedom of choice to which of the analytical devices an upcoming sample analysis process is assigned or allocated. Each sample analysis process exerts predictable and specific load or wear to an analytical device on which it is carried out. This predicted wear and tear can be determined separately for all wear parts of an analytical device (for example the wear of a needle seat, a valve rotor, a pump seal, an injection valve, a detector lamp, etc.). Different analytical devices, such as liquid chromatography apparatuses, may have different wear rates for a particular wear part for the same sample analysis process. A laboratory may strive to utilize the analytical devices as efficient as possible, in particular to avoid downtime. If there are phases in which more samples are to be analyzed than there is laboratory capacity, none of the analytical devices should come to a standstill.

In the above-mentioned framework, an exemplary embodiment of the invention may distribute orders of sample analysis processes to be executed to the analytical devices in such a way that all analytical devices have exhausted their wear potential for a certain wear part (which may also be denoted as functional part) as simultaneously as possible with regard to the wear of a certain wear part. A corresponding allocation may be based on the wear rates determined for the upcoming sample analysis processes.

For the determination of an expected maintenance date of an analytical device, the time until the end of life of a wear part may be determined or estimated under the assumption of a predicted use of said analytical device, i.e. the number of sample analysis processes allocated to this analytical device.

In order to carry out an allocation of sample analysis processes to analytical devices, the wear and tear of the various functional parts caused by the respective sample analysis processes may be taken into account, as well also the runtime of the respective sample analysis process which may also have an impact on the wear rate. To put it shortly, use of each respective analytical device may be adjusted in accordance with a desired maintenance date. In particular, the wear and tear of several analytical devices may be influenced by a defined distribution of functional tasks (i.e. allocation of sample analysis processes) among the analytical devices of a pool so that a common maintenance date for all analytical devices results.

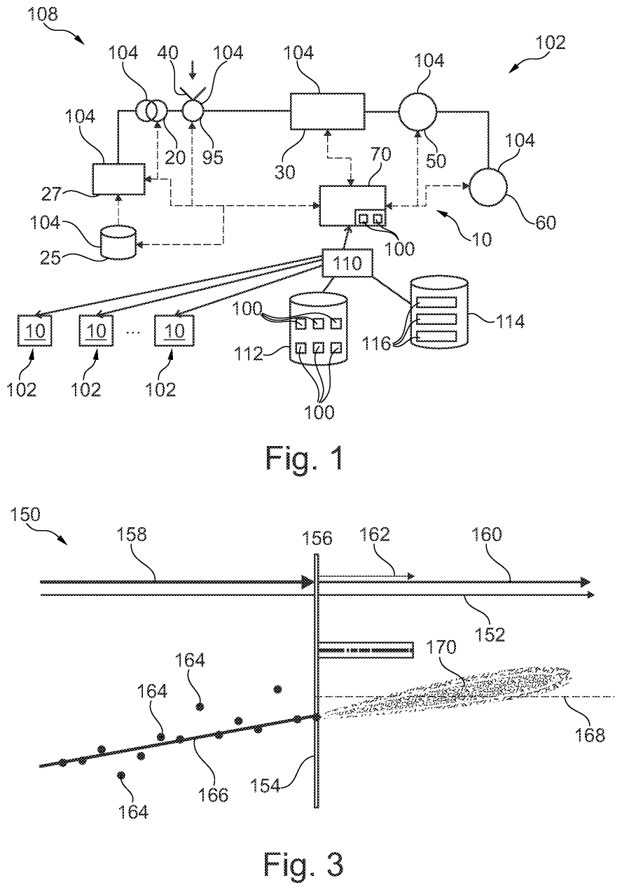

FIG. 1 illustrates an arrangement 108 according to exemplary embodiment of the invention.

Arrangement 108 comprises a plurality of analytical device-type functional devices 102, here each configured as sample separation apparatus 10 (in particular HPLC) having the below described features. Each functional device 102 is capable of carrying out sample analysis process-type functional tasks 100 which may be defined in a task database 112. For instance, each of said functional tasks 100 may correspond to a chromatographic separation method which may be defined by a set of parameters (such as pressure, solvent composition over time, flow rates, etc.) for separating a specific fluidic sample (for example orange juice or a body fluid). Hence, each of said functional tasks 100 may correspond to a respective predefined liquid chromatography process related to analyzing a respective fluidic sample by a respective one of said HPLC-type functional devices 102.

For each functional task 100 when executed on a respective functional device 102, individual functional parts 104 (for instance a separation unit 30, such as a chromatographic separation column) experience a certain wear and tear. The amounts of wear and tear added to the functional parts 104 when carrying out a plurality of functional tasks 100 may lead to a respective functional part 104 approaching a need for maintenance or substitution. To consider this, a wear and tear database 114 includes wear and tear data elements 116 assigned to the individual functional parts 104 of the individual functional devices 102 or assigned to the individual functional devices 102 as a whole and indicating which amount of wear and tear is to be added to a respective functional part 104 or an entire functional device 102 when executing a corresponding functional task 100.

Furthermore, FIG. 1 illustrates a central control unit 110 being communicatively coupled with each of the functional devices 102 and being configured for determining and communicating an allocation of the functional tasks 100 to the individual functional devices 102 based on one or more criteria described below. For example, two functional tasks 100 are assigned to the functional device 102 shown in further detail in FIG. 1, so that a corresponding controller 70 of said functional device 102 will carry out said two allocated functional tasks 100. Alternatively to control unit 110, also a controller 70 of a respective functional device 102 can control the allocation of functional tasks 100 to the functional devices 102, or another allocating entity.

One of the functional devices 102 is illustrated in detail in FIG. 1 and will be explained in the following:

FIG. 1 depicts a general schematic of a liquid chromatography separation system as an example for a sample separation apparatus 10. A pump as an example for a fluid drive unit 20 receives a mobile phase from a solvent supply 25, typically via a degas ser 27, which degases and thus reduces the amount of dissolved gases in the mobile phase. The fluid drive unit 20—such as a high-pressure pump—drives the mobile phase through a sample separation unit 30 (such as a chromatographic column) comprising a stationary phase. A sampling unit or injector 40 can be provided between the fluid drive unit 20 and the sample separation unit 30 in order to subject or add (often referred to as sample introduction) a sample fluid into the mobile phase by switching an assigned injection valve 95. The stationary phase of the sample separation unit 30 is configured for separating compounds of the sample liquid. A detector 50 is provided for detecting separated compounds of the sample fluid. A fractionating unit 60 can be provided for outputting separated compounds of sample fluid.

While the mobile phase can be comprised of one solvent only, it may also be mixed from plural solvents. Such mixing may be a low pressure mixing and provided upstream of the fluid drive unit 20, so that the fluid drive unit 20 already receives and pumps the mixed solvents as the mobile phase. Alternatively, the fluid drive unit 20 may be comprised of plural individual pumping units, with plural of the pumping units each receiving and pumping a different solvent or mixture, so that the mixing of the mobile phase (as received by the sample separation unit 30) occurs at high pressure and downstream of the fluid drive unit 20 (or as part thereof). The composition (mixture) of the mobile phase may be kept constant over time, the so-called isocratic mode, or varied over time, the so-called gradient mode.

Controller 70, which can be a conventional PC or workstation, may be coupled (as indicated by dashed arrows) to one or more of the devices in the sample separation apparatus 10 in order to receive information and/or control operation. For example, the controller 70 may control operation of the fluid drive unit 20 (for instance setting control parameters) and receive therefrom information regarding the actual working conditions (such as output pressure, flow rate, etc., at an outlet of the pump 20). The controller 70 may also control operation of the solvent supply 25 (for instance setting the solvent/s or solvent mixture to be supplied) and/or the degasser 27 (for instance setting control parameters such as vacuum level) and may receive therefrom information regarding the actual working conditions (such as solvent composition supplied over time, flow rate, vacuum level, etc.). The controller 70 may further control operation of the sampling unit or injector 40 (for instance controlling sample injection or synchronization of sample injection with operating conditions of the fluid drive unit 20). The sample separation unit 30 may also be controlled by the controller 70 (for instance selecting a specific flow path or column, setting operation temperature, etc.), and send—in return—information (for instance operating conditions) to the controller 70. Accordingly, the detector 50 may be controlled by the controller 70 (for instance with respect to spectral or wavelength settings, setting time constants, start/stop data acquisition), and send information (for instance about the detected sample compounds) to the controller 70. The controller 70 may also control operation of the fractionating unit 60 (for instance in conjunction with data received from the detector 50) and provides data back.

As already mentioned above, the central control unit 110 is configured for allocating the plurality of functional tasks 100 (in the present example sample analysis processes being HPLC-based sample separation tasks) to the plurality of functional devices 102 shown in FIG. 1. Each of the HPLC-type functional devices 102 may be capable of carrying out some or all of said functional tasks 100, i.e. those for which a respective functional device 102 supports an assigned chromatographic separation method.

Advantageously, the control unit 110 is configured for allocating the functional tasks 100 to the functional devices 102 based on the criterion to achieve compliance with a predefined control target of controlling the functional devices 102. In the described embodiment, the allocation of the functional tasks 100 to the functional devices 102 may be carried out so that at one common temporally coordinated maintenance time of the functional devices 102 wear and tear of the functional devices 102 is balanced. Thus, the predefined control target is related to a temporal coordination when maintenance for the individual functional devices 102 falls due. Even more specifically, the allocation of functional tasks 100 to the functional devices 102 may be controlled by the control unit 110 so that all functional devices 102 are due for maintenance at the same time or in the same time window. Consequently, maintenance staff may maintain all functional devices 102 at the same maintenance time or in the same maintenance time window which is the consequence of the wear and tear balancing allocation of the functional tasks 100 to the functional devices 102.

For balancing wear and tear of the functional devices 102 in view of the allocated functional tasks 100, the wear and tear data elements 116 stored in the wear and tear database 114 and assigned to the individual functional parts 104 of the individual functional devices 102 may be considered. Based on expected wear and tear in view of the allocated future functional tasks 100 and based on additionally determined wear and tear of past functional tasks 100, maintenance time data and/or end-of-life data of the functional parts 104 of the functional devices 102 may be determined. For such a wear and tear evaluation, also hardware data of the functional devices 104 and wear and tear-related information concerning the functional parts 104 may be considered.

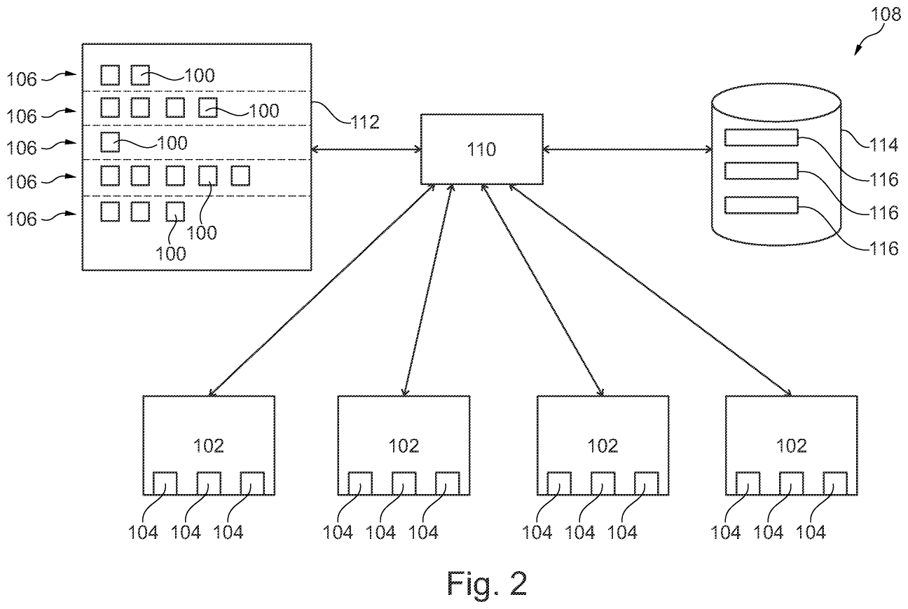

FIG. 2 illustrates an arrangement 108 with functional devices 102, each having a plurality of functional parts 104, and a control unit 110 according to an exemplary embodiment.

The arrangement 108 of FIG. 2 comprises the plurality of functional devices 102 each capable of carrying out some or all of the functional tasks 100. Said functional devices 102 are analytical devices (for instance liquid chromatography sample separation apparatuses). Each of said functional tasks 100 corresponds to a respective predefined process related to analyzing a respective sample by a respective one of said functional devices 102. For instance, each functional task 100 corresponds to a specific chromatographic sample separation method for separating a specific fluidic sample and is characterized by a corresponding parameter set. Furthermore, control unit 110 (for example a processor or a computer) is communicatively coupled with the functional devices 102 and is configured for allocating the functional tasks 100 to be executed to the various functional devices 102 in accordance with one or more control targets being related to a controlled operation of the functional devices 102. The plurality of functional devices 102 may form part of a common localized system, such as a laboratory of a pharmaceutical plant.

The control unit 110 is configured for allocating the plurality of functional tasks 100 to the plurality of functional devices 102. Advantageously, this allocation can be done based on the criterion to achieve compliance with at least one predefined control target of controlling the functional devices 102.

In one embodiment, said at least one control target may relate to wear and tear of the functional devices 102 as a result of the execution of functional tasks 100. Allocation of the functional tasks 100 to the functional devices 102 may be carried out by the control unit 110 so that maintenance times and/or end-of-life times of the functional devices 102 or functional parts 104 thereof are temporarily synchronized. In particular, said allocation can be accomplished so that wear and tear of some or all of the functional devices 102, in view of the execution of the allocated functional tasks 100, is balanced. By taking this measure, it can be temporarily coordinated for the functional devices 102 when maintenance for the individual functional devices 102 or for individual functional parts 104 of at least some of the functional devices 102 falls due. Advantageously, the control target applied by the control unit 110 in terms of allocation of the functional tasks 100 may be that maintenance for the individual functional devices 102 falls due at the same time. Thus, a single maintenance event can be triggered for some or all of the functional devices 102, which may significantly reduce the effort connected with the recruiting of maintenance staff.

However, the at least one control target may also ensure that maintenance for different groups of the individual functional devices 102 falls due at different times for different groups, wherein all functional devices 102 of a common group may share the same maintenance time or the same maintenance time window. Different groups of functional devices 102 may have different maintenance times or different maintenance time windows. For example, a first group (for instance a first half) of the functional devices 102 (such as liquid chromatography sample separation apparatuses) may proceed to maintenance at a first time while a second group (for instance a second half) of the functional devices 102 is on duty for executing allocated sample analysis processes. When the first group has completed maintenance and has returned to the execution of allocated sample analysis processes, maintenance may be executed for the second group. This may ensure that there is never a downtime at which no functional device 102 is available for executing sample analysis processes while simultaneously guaranteeing an efficient maintenance management.

As a basis for an appropriate allocation of functional tasks 100 to the functional devices 102 to thereby adjust appropriate maintenance times, the control unit 110 (or a respective controller 70) may determine wear and tear of the functional devices 102 correlated with functional tasks 100 executed by each respective functional device 102. In particular, the control unit 110 may be configured for estimating an expected maintenance time for the functional devices 102 based on an intended use of a respective one of said functional devices 102 in the future. Hence, the control unit 110 may consider wear and tear to be expected when the functional device 102 will execute allocated functional tasks 100 in the future. Moreover, the estimation of an expected maintenance time for the functional devices 102 may be carried out based on an actual use of each of the functional devices 102 in the past, since this has also led to wear and tear. An expected maintenance time for said functional devices 102 may also be determined based on preknown attributes of a respective functional device 102 and its assigned individual functional parts 104. Wear and tear may depend on a robustness of the functional parts 104, for instance of a type of gasket used in a high-pressure pump. Additionally, determination of an expected maintenance time for said functional devices 102 may also consider preknown attributes of said functional tasks 100 which shall be executed on a respective functional device 102. For example, a chromatographic separation method, as an example for a functional task 100, may specify a mobile phase pressure. A higher mobile phase pressure of a functional task 100 may lead to a larger wear and tear contribution than a smaller mobile phase pressure of another functional task 100. In particular the combination of past functional tasks 100, allocated future functional tasks 100, attributes of a respective functional device 102 and its functional parts 104, as well as attributes of allocated and/or already executed functional tasks 100 may allow to precisely determine cumulated wear and tear and consequently a future maintenance time of a functional device 102, depending on which functional tasks 100 are allocated to such a functional device 100.

For balancing the maintenance times of different functional devices 102, it may be advantageous to allocate less functional tasks 100 to a respective one of said functional devices 102 being closer to an expected maintenance time compared with another functional device 102 being still further away from an expected maintenance time. Hence, more functional tasks 100 may be allocated to the latter mentioned functional device 102.

Additionally or alternatively, said at least one control target relates to a quality of analysis results obtained by the functional devices 102 as a result of the execution of functional tasks 100. For instance, allocation of the functional tasks 100 to the functional devices 102 may be carried out so that a sample separation resolution of each of the allocated functional tasks 100 complies with a predefined resolution threshold value. Thus, at least one control target may be related to a quality of results of analyzing samples when the functional devices 102 carry out the allocated functional tasks 100. For example, an accuracy, such as a separation resolution, of a chromatographic sample separation of analyzed fluidic samples in separated sample components may be used as a criterion for allocating sample analysis processes to the functional devices 102 embodied as liquid chromatography sample separation apparatuses. Accuracy and in particular separation resolution of a chromatographic sample separation process may be related to positions of peaks, spacing between peaks and/or width of peaks in a chromatogram, wherein different peaks may correspond to different components of a separated fluidic sample. When the different functional devices 102 have different chromatographic resolution in terms of sample analysis processes corresponding to specific chromatographic separation methods, the allocation of the sample analysis processes to the liquid chromatography-type functional devices 102 may be carried out so that, for each sample analysis process, a predefined quality criterion is fulfilled. For example, sample separation processes requiring higher accuracy may be carried out by functional devices 102 having a higher level of functionality, whereas sample separation processes being compliant with lower accuracy may be carried out by functional devices 102 having a lower level of functionality.

Additionally or alternatively, said at least one control target relates to an energy consumption of the functional devices 102 as a result of the execution of functional tasks 100. For instance, allocation of the functional tasks 100 to the functional devices 102 may be carried out so that the energy consumption for executing the functional tasks 100 allocated to the individual functional devices 102 complies with a predefined energy consumption threshold value, for instance does not exceed a maximum energy consumption threshold value. Thus, at least one control target may be related to device energy consumption in terms of analyzing samples when the functional devices 102 carry out the allocated functional tasks 100. For example, an overall energy consumption of a plurality of chromatographic sample separation tasks of analyzing fluidic samples in separated sample components may be used as a criterion for allocating sample analysis processes to the functional devices 102 embodied as liquid chromatography sample separation apparatuses. Energy consumption of a chromatographic sample separation process may depend both on used hardware, i.e. the functional parts 104 of the HPLC-type functional devices 102, and on an executed chromatographic separation method (for instance, executing a liquid sample separation analysis with a mobile phase pressure of 1200 bar may consume more energy than another sample separation analysis with a mobile phase pressure of 200 bar). When the different functional devices 102 have different energy consumptions in terms of sample analysis processes corresponding to specific chromatographic separation methods, the allocation of the sample analysis processes to the liquid chromatography-type functional devices 102 may be carried out so that, for each sample analysis process or for an entire set of sample analysis processes to be allocated, a predefined energy consumption criterion is fulfilled.

Still referring to FIG. 2, the functional tasks 100 may be grouped into sets 106 of functional tasks 100. These sets 106 may have the same size or may have different sizes. It may then be possible to allocate each set 106 of the functional tasks 100 to only one of said functional devices 102. For functional tasks 100 relating to a common set 106, the task allocation algorithm may be carried out under consideration of the additional boundary condition that functional tasks 100 of a respective set 106 shall be executed only by exactly one functional device 102. For example, for reasons of comparability and/or reproducibility of results of sample analysis processes, a user may define that a corresponding set 106 has to be executed on the same instrument, i.e., on the same functional device 102 (for example a liquid chromatography (LC) sample separation apparatus). Thus, the allocation of the functional tasks 100 to the functional devices 102 may be executed under additional consideration of one or more user-defined boundary conditions.

FIG. 3 is a diagram 150 illustrating a working principle of a method, a control unit 110 and an arrangement 108 according to an exemplary embodiment.

Diagram 150 has an abscissa 152 along which the time is plotted. Along an ordinate 154, a leakage rate of a seal or gasket of a functional device 102 is plotted. A present point of time, i.e. an actual status, is indicated with reference sign 156. Correspondingly, the past (indicating trending) is represented by reference sign 158, and the future (corresponding to a prediction) corresponds to reference sign 160. A task queue corresponding to samples and/or sequences is indicated by reference sign 162.

Measurement points 164 indicate measured leakage rates determined in the past. For instance, leakage rate may be measured following application of a high test pressure. A linear regression line 166 corresponding to said measurement points 164 is plotted in FIG. 3 as well. A predefined leakage rate threshold value which, when exceeded, requires maintenance (or substitution) of the seal because the leakage rate becomes unacceptably high, is indicated by reference sign 168. A cloud 170 corresponds to an expected future development of the leakage rate due to continued tear and wear exerted to the seal. Thus, depending on an amount of a future use of the functional device 102 having said seal (as an example for a functional part 104 of functional device 102), a different region of the cloud 170 will be entered, and an expected maintenance or exchange time will be modified accordingly.

Based on FIG. 3, allocation of future sample analysis processes to be carried out by the analytical device having the described seal may be carried out for adjusting a desired maintenance time or end of lifetime of the seal.

Advantageously, prediction dynamic maintenance intervals may make intelligent predictions to help a user determine if an analysis (for instance a single run) may be completed as the user expects. Dynamic maintenance intervals may make this determination based on current instrument signals, as well as the trending of past instrument signals in order to make a best guess as to how the future instrument status will be during the run. Dynamic maintenance intervals may guide the user to make the best decision possible. A Task Queue Status (TQS) may indicate if the task queue can be completed without human interaction by evaluating the status from online diagnostic, trending, and prediction. Dynamic maintenance intervals may be advantageously user configurable. Lab managers can determine if certain users can override an analysis that is not recommended by the dynamic maintenance interval. Notifications can be customized (for example what type, when to receive, for what issues, etc.).

It will be understood that one or more of the processes, sub-processes, and process steps described herein may be performed by hardware, firmware, software, or a combination of two or more of the foregoing, on one or more electronic or digitally-controlled devices. The software may reside in a software memory (not shown) in a suitable electronic processing component or system such as, for example, the controller 70 and/or control unit 110 schematically depicted in FIG. 1. The software memory may include an ordered listing of executable instructions for implementing logical functions (that is, “logic” that may be implemented in digital form such as digital circuitry or source code, or in analog form such as an analog source such as an analog electrical, sound, or video signal). The instructions may be executed within a processing module, which includes, for example, one or more microprocessors, general purpose processors, combinations of processors, digital signal processors (DSPs), application specific integrated circuits (ASICs), field-programmable gate array (FPGAs), etc. Further, the schematic diagrams describe a logical division of functions having physical (hardware and/or software) implementations that are not limited by architecture or the physical layout of the functions. The examples of systems described herein may be implemented in a variety of configurations and operate as hardware/software components in a single hardware/software unit, or in separate hardware/software units.

The executable instructions may be implemented as a computer program product having instructions stored therein which, when executed by a processing module of an electronic system (e.g., the controller 70 and/or control unit 110 schematically depicted in FIG. 1), direct the electronic system to carry out the instructions. The computer program product may be selectively embodied in any non-transitory computer-readable storage medium for use by or in connection with an instruction execution system, apparatus, or device, such as an electronic computer-based system, processor-containing system, or other system that may selectively fetch the instructions from the instruction execution system, apparatus, or device and execute the instructions. In the context of this disclosure, a computer-readable storage medium is any non-transitory means that may store the program for use by or in connection with the instruction execution system, apparatus, or device. The non-transitory computer-readable storage medium may selectively be, for example, an electronic, magnetic, optical, electromagnetic, infrared, or semiconductor system, apparatus, or device. A non-exhaustive list of more specific examples of non-transitory computer readable media include: an electrical connection having one or more wires (electronic); a portable computer diskette (magnetic); a random access memory (electronic); a read-only memory (electronic); an erasable programmable read only memory such as, for example, flash memory (electronic); a compact disc memory such as, for example, CD-ROM, CD-R, CD-RW (optical); and digital versatile disc memory, i.e., DVD (optical). Note that the non-transitory computer-readable storage medium may even be paper or another suitable medium upon which the program is printed, as the program may be electronically captured via, for instance, optical scanning of the paper or other medium, then compiled, interpreted, or otherwise processed in a suitable manner if necessary, and then stored in a computer memory or machine memory.

It should be noted that the term “comprising” does not exclude other elements or features and the term “a” or “an” does not exclude a plurality. Also elements described in association with different embodiments may be combined. It should also be noted that reference signs in the claims shall not be construed as limiting the scope of the claims.

1. A method of allocating a plurality of functional tasks to a plurality of functional devices each capable of carrying out one or more of the functional tasks, wherein the functional devices are analytical devices and each of the functional tasks corresponds to a respective predefined process related to analyzing a respective sample by a respective one of the functional devices, the method comprising allocating the functional tasks to the functional devices based on a criterion to achieve compliance with at least one predefined control target of controlling the functional devices.

2. The method according to claim 1, wherein at least one of the at least one predefined control target is related to wear and tear of the functional devices or of individual functional parts of at least some of the functional devices when carrying out the allocated functional tasks.

3. The method according to claim 2, wherein the method comprises allocating the functional tasks to the functional devices so that at one or more temporally coordinated maintenance times of the functional devices or of individual functional parts of at least some of the functional devices, wear and tear of the functional devices or of individual functional parts of at least some of the functional devices is balanced.

4. The method according to claim 1, wherein at least one of the at least one predefined control target is related to a temporal coordination when maintenance for the individual functional devices or for individual functional parts of at least some of the functional devices falls due.

5. The method according to claim 1, wherein at least one of the at least one predefined control target is related to a temporal coordination when the individual functional devices or individual functional parts of at least some of the functional devices reach an end of lifetime and require substitution.

6. The method according to claim 1, wherein at least one of the at least one predefined control target is related to a quality of results of analyzing samples or to an accuracy of a separation of analyzed samples in separated sample components, when the functional devices or individual functional parts of at least some of the functional devices carry out the allocated functional tasks.

7. The method according to claim 1, wherein at least one of the at least one predefined control target is related to an energy consumption of the functional devices or individual functional parts of at least some of the functional devices when carrying out the allocated functional tasks.

8. The method according to claim 1, wherein at least one of the at least one predefined control target is that maintenance for the individual functional devices or individual functional parts of at least some of the functional devices falls due temporally synchronized.

9. The method according to claim 1, comprising one of the following features:
wherein at least one of the at least one predefined control target is that maintenance for the individual functional devices or individual functional parts of at least some of the functional devices falls due within a predefined common time interval for at the same time;
wherein at least one of the at least one predefined control target is that maintenance for different groups of the individual functional devices or different groups of individual functional parts of at least some of the functional devices falls due within different predefined time intervals for different groups or at different times for different groups.

10. The method according to claim 1, comprising at least one of the following features:
wherein the method comprises estimating an expected maintenance time and/or an expected end of lifetime for at least some of the functional devices or for individual functional parts of at least some of the functional devices as a basis for assessing the at least one predefined control target;
wherein the method comprises estimating an expected maintenance time and/or an expected end of lifetime for at least some of the functional devices or for individual functional parts of at least some of the functional devices based on an intended use of a respective one of the functional devices or of individual functional parts of at least some of the functional devices in the future;
wherein the method comprises estimating an expected maintenance time and/or an expected end of lifetime for at least some of the functional devices or for individual functional parts of at least some of the functional devices based on an actual use of a respective one of the functional devices or of individual functional parts of at least some of the functional devices in the past;
wherein the method comprises estimating an expected maintenance time and/or an expected end of lifetime for at least some of the functional devices or for individual functional parts of at least some of the functional devices based on preknown attributes of a respective one of the functional devices or of individual functional parts of at least some of the functional devices and/or based on preknown attributes of the functional tasks;
wherein the method comprises allocating less functional tasks to a respective one of the functional devices or to an individual functional part of a respective one of the functional devices being closer to an expected maintenance time or being closer to an expected end of lifetime compared with at least one other functional device or compared with a corresponding other functional part of at least one other functional device;
wherein at least one of the at least one predefined control target is that wear and tear of at least one selected functional device is to be smaller than wear and tear of at least one other of the functional devices.

11. The method according to claim 1, wherein at least one of the at least one predefined control target is that a number of sets of functional tasks executed by the functional devices meets a predefined target specification or is maximized.

12. The method according to claim 1, wherein the method comprises dynamically adjusting at least one maintenance time at which maintenance of the functional devices or at least an individual functional part of the functional devices is due.

13. The method according to claim 1, wherein the functional tasks are grouped into sets of functional tasks, and wherein the method comprises allocating each set of the functional tasks to only one of the functional devices.

14. A control unit for allocating a plurality of functional tasks to a plurality of functional devices each capable of carrying out one or more of the functional tasks, wherein the functional devices are analytical devices and each of the functional tasks corresponds to a respective predefined process related to analyzing a respective sample by a respective one of the functional devices, and wherein the control unit is configured for allocating the functional tasks to the functional devices based on a criterion to achieve compliance with at least one predefined control target of controlling the functional devices.

15. The control unit according to claim 14, wherein at least one of the at least one predefined control target is related to wear and tear of the functional devices or of individual functional parts of at least some of the functional devices when carrying out the allocated functional tasks.

16. An arrangement, comprising:
a plurality of functional devices each capable of carrying out one or more functional tasks, wherein the functional devices are analytical devices and each of the functional tasks corresponds to a respective predefined process related to analyzing a respective sample by a respective one of the functional devices; and
at least one control unit according to claim 14.

17. The arrangement according to claim 16, wherein the functional devices are sample separation apparatuses for separating a fluidic sample.

18. The arrangement according to claim 17, wherein each sample separation apparatus comprises:
a fluid drive unit) configured for driving a mobile phase and the fluidic sample injected in the mobile phase; and
a sample separation unit configured for separating the fluidic sample in the mobile phase.

19. The arrangement according to claim 17, wherein each sample separation apparatus further comprises at least one of the following features:
the sample separation apparatus is configured as at least one of: a chromatography sample separation apparatus; a liquid chromatography sample separation apparatus; a gas chromatography sample separation apparatus; a supercritical fluid chromatography sample separation apparatus;
the sample separation unit is a chromatographic separation column;
comprising an injector configured to inject the fluidic sample into the mobile phase;
comprising a detector configured to detect the separated fluidic sample;
comprising a fractionating unit configured to collect the separated fluidic sample;
comprising a degassing apparatus for degassing at least part of the mobile phase.

20. The arrangement according to claim 16, wherein the plurality of functional devices form part of at least one of: a localized system; a fleet; a lab; a site.
